(19) United States
(12) Patent Application Publication
(10) Pub. No.: US 2023/0146626 A1
(43) Pub. Date: May 11, 2023

(54) DEVICE FOR DISPLAYING A SUCCESSION OF INDICATIONS OF A TIME VARIABLE FOR A TIMEPIECE

(71) Applicant: Montres Breguet S.A., L'Abbaye (CH)

(72) Inventors: Fabrice ROCHAT, Vallorbe (CH); Polychronis Nakis KARAPATIS, Premier (CH)

(73) Assignee: Montres Breguet S.A., L'Abbaye (CH)

(21) Appl. No.: 17/884,883

(22) Filed: Aug. 10, 2022

(30) Foreign Application Priority Data
Nov. 10, 2021 (EP) 21207561.8

(51) Int. Cl. G04B 19/26; G04B 19/02

(52) U.S. Cl. CPC G04B 19/268; G04B 19/02

(57) ABSTRACT

A device (1) for displaying a succession of indications of a time variable for a timepiece, this display device (1) including an indicator which carries the succession of indications of the time variable to be displayed, and is arranged to be driven by a horological movement to move from an initial position to a final position through a succession of intermediate positions in which the display of the time variable passes from one indication to the next indication at a required frequency. Also included is a mechanism (22; 72) for positioning the indicator in a reference position and an actuating device, the mechanism including a cam on which acts, when actuated, the actuating device such that the mechanism brings the indicator back to its predetermined reference position.

### CROSS REFERENCE TO RELATED APPLICATION

The present application is based on, and claims priority from the prior European Patent Application No. 21207561.8, filed on Nov. 10, 2021, the entire contents of which are incorporated herein by reference.

### TECHNICAL FIELD OF THE INVENTION

The present invention relates to a device for displaying a succession of indications of a time variable for a timepiece. More specifically, the present invention relates to such a device for displaying a succession of indications of a time variable that is equipped with a device for correcting the display.

### TECHNOLOGICAL BACKGROUND

The present invention relates to devices for displaying a succession of indications of a time variable, such as devices for displaying moon phases or even devices for displaying weeks, which are comprised in timepieces, in particular of the wristwatch type, and whose correction requires or is facilitated by a prior reset. By way of example, the correction of a device for displaying the moon phases requires counting the days since the last full moon, whereas the correction of a device for displaying the weeks, also referred to as a weekly calendar, which displays a number of weeks that may differ from one year to the next, is facilitated by carrying out a reset at the beginning of the year.

A moon phase display device allows the different phases of the moon to be displayed (new moon, waxing crescent moon, 1^{st} quarter, waxing gibbous moon, full moon, waning gibbous moon, last quarter and waning crescent moon) which follow one another during a lunar month, the duration whereof between two consecutive new moons is 29 days, 12 hours, 44 minutes and 2.8 seconds. In the mechanical horological field, this duration, which is also referred to as a lunation, is rounded to 29.5 days and usually progresses by 1 step per day. The correction of a moon phase display device is thus also carried out in 1-day steps, and the correction method usually recommended to the customer is to bring the display to an easily identifiable reference position, for example the full moon, by manipulating a day-by-day corrector, then to count the number of days separating the full moon from the age of the moon on the given day, and finally to bring the moon phase display, also in 1-day steps by means of the day-by-day corrector, into the appropriate position. It is thus understood that the correction of a moon phase display device can require 29 corrections to bring this device into the position in which it displays the full moon, and then up to 29 further corrections to bring the device into the position corresponding to the age of the moon on the given day.

A device for displaying the weeks, also referred to as a weekly calendar, shows the weeks that have passed in the year. Such a weeks display device includes, depending on the design, a 1-53 hand or single-aperture display by means of a single disc, or a 00-59 “large date” type display with a display for the units (0-9) by way of a first disc and a display for the tens (0-5) by way of a second disc. As the years do not always contain the same number of weeks, the correction method usually recommended to the customer is to bring the weeks display device to its initial position, i.e. to position 1. For a hand display or a single-aperture display, the correction is easy to carry out. On the other hand, to the best of the Applicant's knowledge, there is no method for correcting the display such that it can be instantly brought back to position 01 without having to go through positions 54 to 00 in the case of a “large date” type display.

These various types of devices for displaying a succession of indications of a time variable exist in many forms. The improvements made thereto usually concern the accuracy of the display or the aesthetics of the information displayed.

However, no entirely satisfactory solution has yet been found to some problems relating to the use of these display devices. This is in particular the case when, after the watch has been stopped for a long period of time, these display devices must be set so that they provide the correct indication again. More specifically, it is understood that the operations for setting some display devices, such as a moon phase display device or a weeks display device, after the timepiece in which these display devices are comprised has been stopped for a more or less extended period of time, can be long and tedious.

### SUMMARY OF THE INVENTION

The present invention aims to overcome the aforementioned problems as well as others by providing a device for displaying a succession of indications of a time variable for a timepiece with facilitated correction of the display.

For this purpose, the present invention relates to a device for displaying a succession of indications of a time variable for a timepiece, this display device comprising an indicator which carries the succession of indications of the time variable to be displayed or which points to this succession of indications of the time variable to be displayed, this indicator being arranged to be driven by a horological movement so as to move from an initial position to a final position through a succession of intermediate positions in which the display of the time variable passes from one indication to the next indication at a required frequency, the display device further comprising a mechanism for positioning the indicator in a reference position and an actuating device, the mechanism for positioning the indicator in a reference position comprising at least a cam on which acts, when actuated, the actuating device such that the mechanism for positioning the indicator in a reference position brings the indicator back to its predetermined reference position.

According to one specific embodiment of the invention, the cam is a heart-piece or a snail the positioning whereof, relative to the indicator, determines the predetermined reference position of the indicator.

According to another specific embodiment of the invention, the mechanism for positioning the indicator in a reference position comprises a hammer, the hammer being arranged such that, when actuated by means of the actuating device, it comes into an active position in contact with the heart-piece or snail, so as to pivot the indicator and bring it back into its predetermined reference position.

According to yet another specific embodiment of the invention, the heart-piece or the snail is mounted such that it is fixed to the indicator.

According to yet another specific embodiment of the invention, the cam is a heart-piece or a snail fixedly mounted on a frame of the timepiece and the mechanism for positioning the indicator in a reference position comprises a hammer mounted on the indicator.

According to yet another specific embodiment of the invention, in order for the hammer to be actuated, the actuating device comprises a push button which acts against the elastic force of a spring arranged to keep the hammer away from an active position in contact with the heart-piece or snail.

According to yet another specific embodiment of the invention, the indicator is a 59-tooth moon phase wheel which carries two moon indications and which is driven by the horological movement at a rate of one step per day.

According to yet another specific embodiment of the invention, the predetermined reference position of the moon phase wheel corresponds to the full moon display position.

According to yet another specific embodiment of the invention, the indicator is a 53-tooth wheel displaying the weeks of the year which carries an indicator hand which moves opposite a graduation bearing the week numbers from 1 to 53.

According to yet another specific embodiment of the invention, the reference position of the weeks of the year display wheel corresponds to the week “1” display position.

According to yet another specific embodiment of the invention, the device for displaying a succession of indications of a time variable is of the “large date” type and comprises a units display assembly for displaying the units of the week numbers, and a tens display assembly for displaying the tens of the week numbers.

According to yet another specific embodiment of the invention, the units display assembly comprises a units disc on which the units of the week numbers 0 to 9 are inscribed and which is fixed to a units star-wheel with 10 teeth, and the tens display assembly comprises a tens disc on which the tens of the week numbers 0 to 5 are inscribed and which is fixed to a tens star-wheel with 6 teeth, the mechanism for positioning the indicator at a reference position comprising a heart-piece or a snail arranged to be fixedly mounted beneath each of the units and tens star-wheels, and the actuating device comprising a hammer falling on the heart-pieces or snails and causes the units disc and the tens disc to be pivoted simultaneously in order to bring them back into their predetermined reference position.

According to yet another specific embodiment of the invention, the predetermined reference position of the units disc and of the tens disc corresponds to the display of the indication “01”.

According to yet another specific embodiment of the invention, the positioning, into the reference position, of the indicator carrying the succession of indications of the time variable to be displayed or pointing to the succession of indications of the time variable to be displayed can be controlled by the user, for example, by acting on a first push button, whereas a second push button is arranged to ensure the stepped correction of the indicator, independently of the first push button.

According to yet another specific embodiment of the invention, the positioning, into the reference position, of the indicator carrying the succession of indications of the time variable or pointing to the succession of indications of the time variable to be displayed is carried out automatically upon a first action on a push button which is arranged to control the stepped correction of the indicator upon a second action on the same push button.

According to yet another specific embodiment of the invention, the driving, correction and return to the reference position of the indicator carrying the succession of indications of the time variable to be displayed or pointing to the succession of indications of the time variable to be displayed are carried out by a wolf-toothed rack, the driving and correction of the indicator being carried out by driving the wolf-toothed rack by one tooth, the reverse motion whereof is prevented by a pawl, and the return of the indicator to the reference position being ensured by actuating the pawl, which releases the wolf-toothed rack, the latter returning to its rest position under the action of a return spring, in which the pawl engages with a tooth provided at the end of this wolf-toothed rack.

The present invention further relates to a timepiece comprising at least one device for displaying a succession of indications of a time variable to be displayed, equipped with a mechanism for positioning, into a reference position, an indicator carrying the succession of indications of the time variable to be displayed or pointing to this succession of indications of the time variable to be displayed.

In the case where the timepiece comprises a plurality of display devices, these are arranged such that they can be repositioned simultaneously into the reference position by one and the same action of the user on a single push button.

Thanks to these features, the present invention provides a device for displaying a succession of indications of a time variable for a timepiece comprising a mechanism for the instant repositioning thereof into a reference position when requested by the user or automatically upon each first correction. Thus, after the timepiece in which the display device is embedded has been stopped for a more or less extended period of time, the display device can be brought back into its initial position by simply actuating a hammer, which acts on a cam integral with the indicator which carries the succession of indications of the time variable to be displayed or which points to this succession of indications of the time variable to be displayed in order to bring this indicator back into its initial position. In the case where the display device according to the invention is used, for example, to display the moon phases, the tedious operation of pressing a push button from 1 to 30 times, depending on the day on which the timepiece stopped, in order to bring a conventional moon phase display device back into the position corresponding to the beginning of the lunar month is thus no longer necessary. In the case where the mechanism for positioning the indicator in a reference position comprises a heart-piece, the correction of the display device can be carried out in both directions of rotation. However, in the case where a snail is used, the correction of the display device is always carried out in the same direction of rotation, which is of particular interest in particular in the case of a “large date” type of week display device with a units display (0-9) by way of a first disc and a tens display (0-5) by way of a second disc. More specifically, by forcing the correction of the units display and of the tens display in the opposite direction of rotation to that of the normal display of the week numbers, the “large date” display device no longer briefly shows the non-existent week numbers 54 to 59.

### BRIEF DESCRIPTION OF THE FIGURES

Other features and advantages of the present invention will be better understood upon reading the following detailed description of one embodiment of the display device according to the invention, said example being provided for the purposes of illustration only and not intended to limit the scope of the invention, given with reference to the accompanying drawing, in which:

FIG. 1 is a top view of a moon phase display device equipped with a mechanism for positioning an indicator in the reference position according to the invention;

FIG. 2 is a bottom view of the moon phase display device showing the mechanism for positioning an indicator in the reference position formed by a heart-piece and a hammer;

FIG. 3 is a view similar to that of FIG. 2 showing the case where the mechanism for positioning an indicator in the reference position is formed by a snail and a hammer;

FIG. 4 is a top view of a weeks of the year display device equipped with a mechanism for positioning an indicator in the reference position according to the invention;

FIG. 5 is a bottom view of the weeks of the year display device showing the mechanism for positioning an indicator in the reference position formed by a snail and a hammer;

FIG. 6 is a top view of a display device intended to show the weeks of the year of the “large date” type;

FIG. 7 is a view similar to that of FIG. 6, with the “large date” weeks of the year display device being supplemented by a correcting lever controlled by means of a push button;

FIG. 8 is a view similar to that of FIGS. 6 and 7, in which the finger for driving the tens fixed to the units star-wheel is visible, and which increments the tens display assembly by one step every 10 weeks;

FIG. 9 is a view similar to that of FIGS. 6 to 8, with the “large date” weeks of the year display device being supplemented by its mechanism for positioning the indicator in a reference position according to the invention;

FIG. 10 is a top view of a display device in which the driving, correction and repositioning, into the reference position, of a hand pointing to the succession of indications of the time variable to be displayed are carried out by a wolf-toothed rack.

### DETAILED DESCRIPTION OF THE INVENTION

The present invention was drawn from the general inventive idea consisting of equipping a device for displaying a succession of indications of a time variable such as the phases of the moon or the weeks of the year with a mechanism for positioning an indicator into a reference position, allowing the indicator which carries the succession of indications or which points to this succession of indications to be instantly brought back to its initial position upon a simple action on a hammer which acts on a cam integral with the indicator. Thus, in the event the timepiece in which the display device according to the invention is embedded is stopped for a more or less extended period of time, it is very easy to bring the indicator back to its initial position and then, from this initial position, to manually set the position of this indicator as a function of the current day.

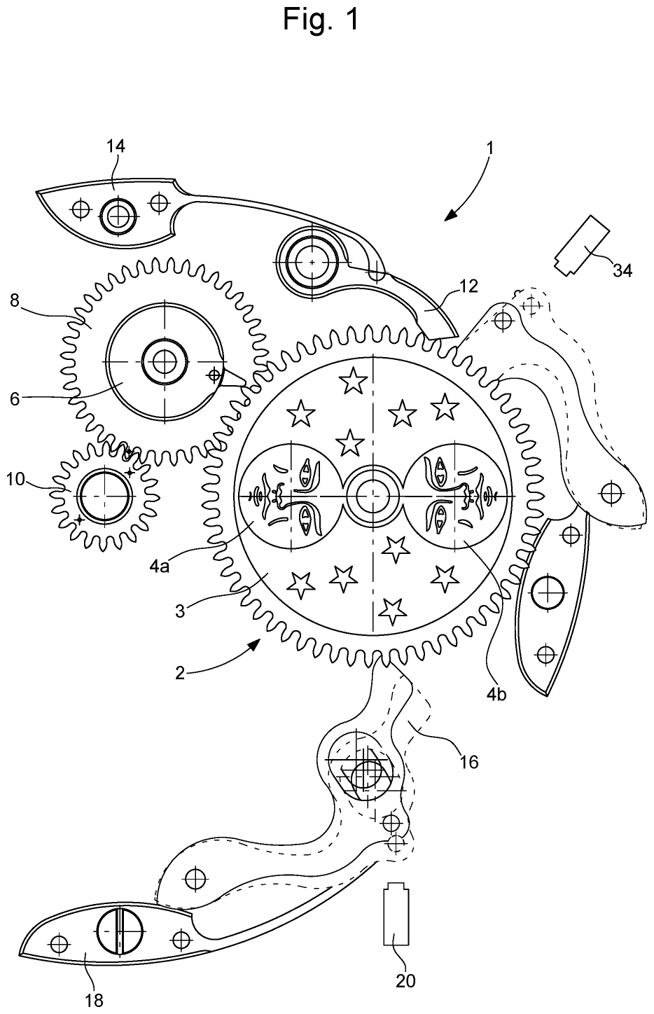

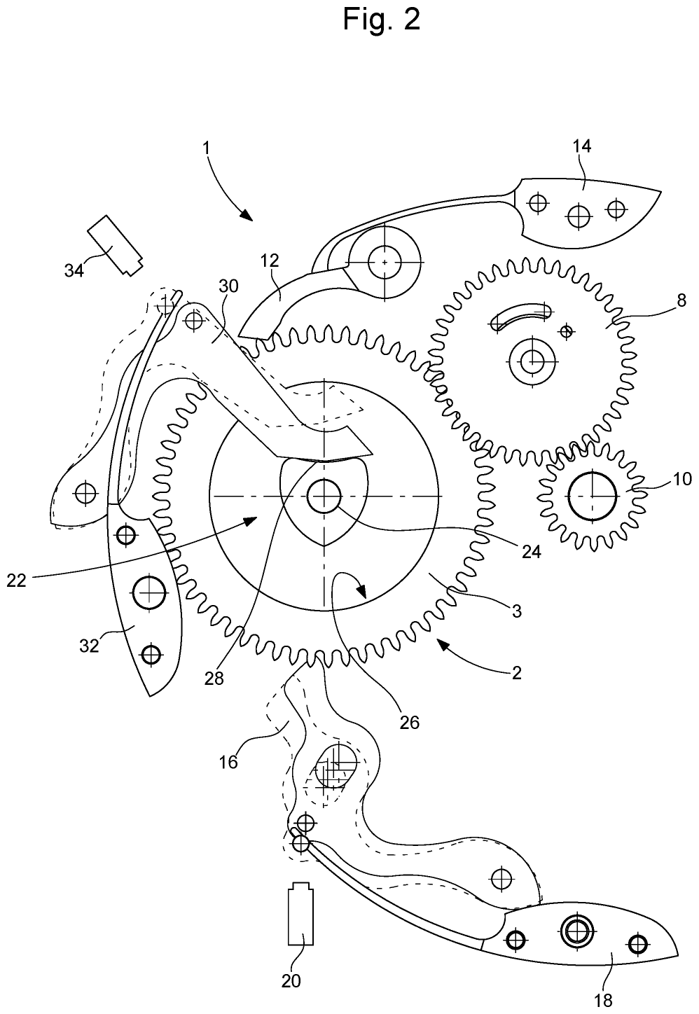

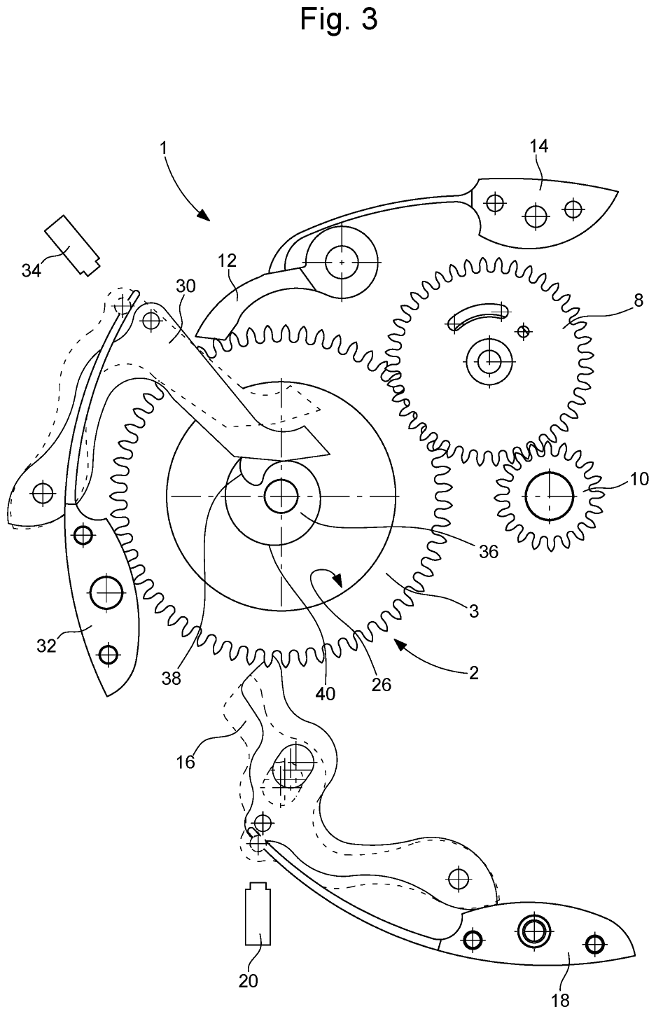

According to one specific embodiment of the invention illustrated in FIGS. 1 and 2 annexed hereto, the device for displaying a succession of indications of a time variable is provided in order to display the moon phases. Denoted as a whole by the general reference numeral 1, the device for displaying a succession of indications of a time variable comprises a moon phase indicator 2. Preferably, but in a non-limiting manner, this moon phase indicator 2 is a 59-tooth moon phase wheel 3 which carries two moon indications 4a and 4b for displaying the moon phases through an aperture provided in a dial of the timepiece (not shown) wherein the device 1 for displaying a succession of indications of a time variable according to the invention is embedded. This moon phase wheel 3 is driven at a rate of one step per day by a drive finger 6 fixedly mounted on a 24-hour wheel 8 which is itself driven by an hour wheel 10 at a rate of one complete revolution per day. This moon phase wheel 3 is held in position by a jumper 12 elastically loaded by a first spring 14. The device 1 for displaying a succession of indications of a time variable further comprises a correcting lever 16 which, in normal circumstances, is held away from the moon phase wheel 3 by the action of a second spring 18. This correcting lever 16 is arranged to advance the moon phase wheel 3 step by step and to allow the moon phase display to be corrected when the user of the timepiece actuates a first push button 20.

In accordance with the invention, the device 1 for displaying a succession of indications of a time variable is equipped with a mechanism 22 for positioning an indicator in a reference position which comprises a cam, for example in the form of a heart-piece 24, fixedly mounted on a lower face 26 of the moon phase wheel 3. This heart-piece 24 has an indexing face 28 via which it cooperates with a hammer 30 which is held elastically away from its active position in contact with the indexing face 28 of the heart-piece 24 by a third spring 32. When the user uses a second push button 34 to act on the hammer 30 against the elastic force of the third spring 32, the hammer 30 falls onto the heart-piece 24 and causes the latter to pivot until this hammer 30 bears in a stable manner on the indexing face 28 of the heart-piece 24. The position of the heart-piece 24 relative to the moon phase wheel 3 is adjusted such that, when the hammer 30 falls on the heart-piece 24, the moon phase wheel 3 is brought back to its reference position, preferably to the full moon display position.

According to one specific embodiment of the invention, the heart-piece 24 of the mechanism 22 for positioning the indicator in a reference position is replaced by a snail 36. The mechanism 22 for positioning the indicator in a reference position remains otherwise unchanged. In the event that a heart-piece 24 is used to bring the moon phase wheel 3 back to its reference position, depending on where on the profile of this heart-piece 24 the hammer 30 falls, the moon phase wheel 3 will rotate in one direction or the other until the hammer 30 comes to bear on the indexing face 28. In the event that a snail 36 is used, the moon phase wheel 3 will always rotate in the same direction, regardless of where on the profile of the snail 36 the hammer 30 falls, and will stop when the hammer 30 comes to bear on the end 38 of the spiral 40 of the snail 36.

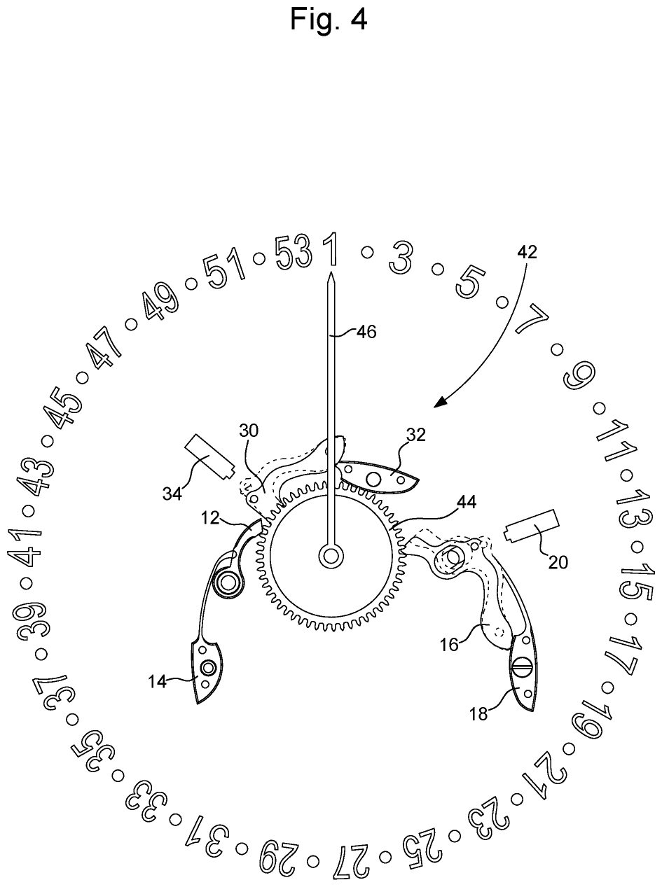

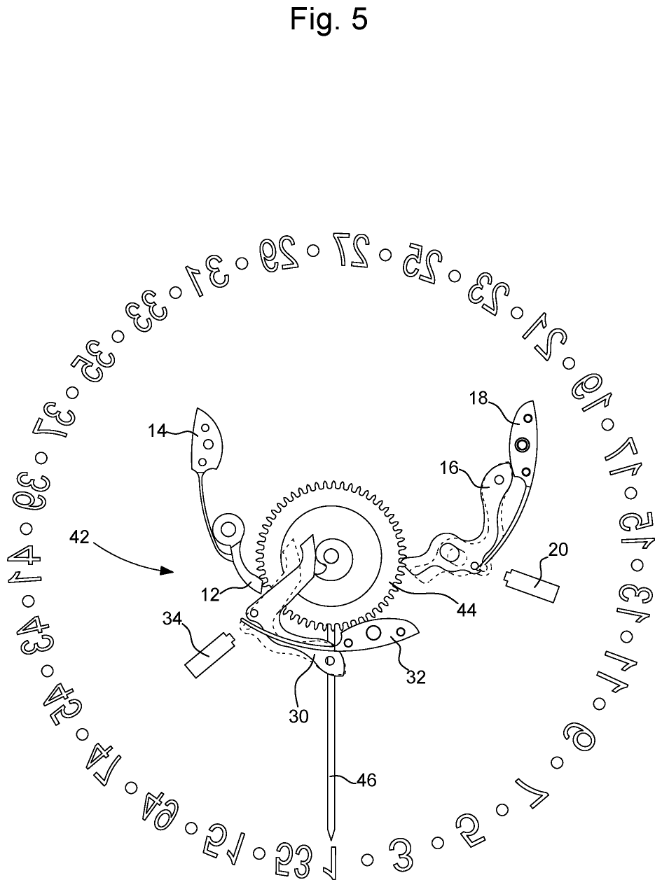

The case where the display device is intended to display the weeks of the year will now be examined. Denoted as a whole by the general reference numeral 42, such a weeks of the year display device comprises an indicator indicating the weeks of the year. Preferably but in a non-limiting manner, this indicator indicating the weeks of the year is a 53-tooth wheel 44 displaying the weeks of the year which bears an indicator hand 46 which moves opposite a graduation bearing the week numbers from 1 to 53 (see FIGS. 4 and 5). The mechanism 22 for positioning the weeks of the year display wheel 44 in a position reference remains otherwise unchanged. The weeks of the year display wheel 44 is driven at a rate of one step per week. When the weeks of the year display wheel 44 is brought back to its reference position, in which the indicator hand 46 preferably points to the week of the year number 1 indication, by actuating the hammer 30, this weeks of the year display wheel 44 always rotates in the same direction thanks to the use of the snail 36.

The use of the snail 36 is particularly advantageous in the case where the indicator hand 46 does not make a complete revolution to display the weeks of the year. More specifically, it can be provided that the display of the weeks from 1 to 53 takes place, for example, only about an angular sector of 270° between 1:30 and 10:30, in order to avoid overloading the dial at noon, where the indication “12” is usually emphasized by a larger or thicker display. In such a case, by bringing the indicator hand 46 back to its reference position by means of the snail 36, this indicator hand 46 can be rotated in the opposite direction to that in which it rotates to display the numbers of the weeks from 1 to 53, such that there is no longer a risk of the indicator hand 46 passing into the sector of the dial where the indication “12” is displayed.

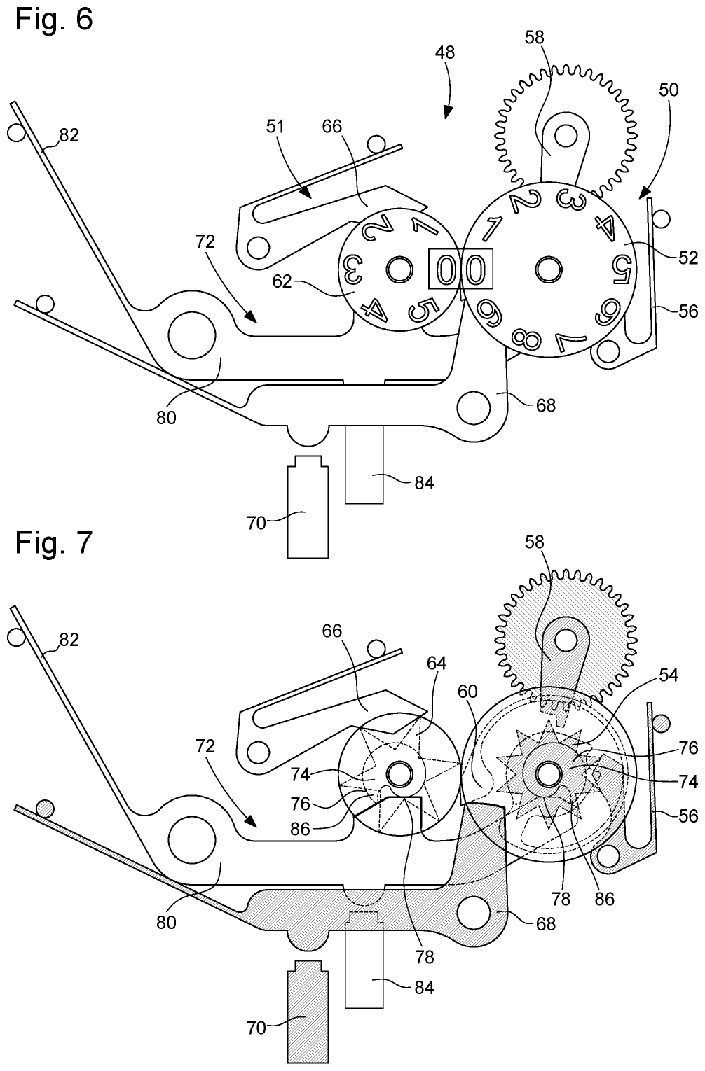

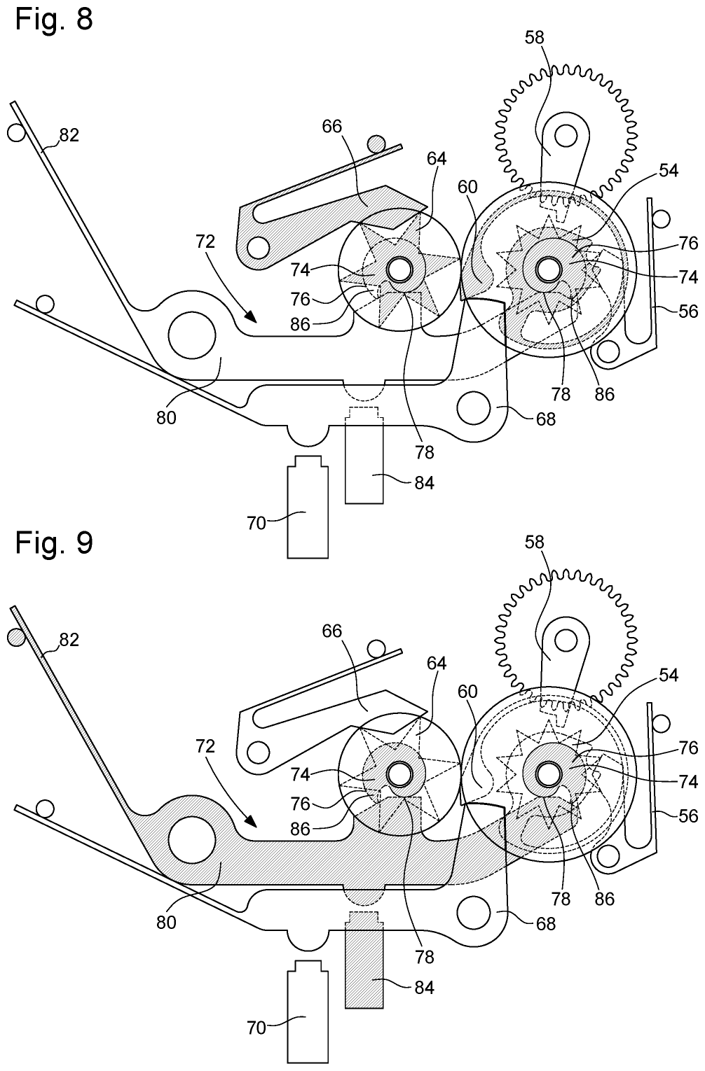

According to another specific embodiment of the invention shown in FIGS. 6 to 9, the display device provided for displaying the weeks of the year is of the “large date” type. Denoted as a whole by the general reference numeral 48, the “large date” display device comprises a units display assembly 50 and a tens display assembly 51.

The units display assembly 50 comprises a units disc 52 on which the units of the week numbers 0 to 9 are inscribed. This units disc 52 is fixed to a units star-wheel 54 which has 10 teeth. The position of this units star-wheel 54 is indexed by a units jumper 56. This units star-wheel 54 is driven at a rate of one step per week by a units drive finger 58. The units display assembly 50 further comprises a tens drive finger 60 fixed to the units star-wheel 54 which increments the tens display assembly 51 by one step at the end of every 9 weeks.

The tens display assembly 51 comprises a tens disc 62 on which the tens of the week numbers 0 to 5 are inscribed. This tens disc 62 is fixed to a tens star-wheel 64 which has 6 teeth. The position of this tens star-wheel 64 is indexed by a tens jumper 66. When changing from the unit of weeks “9” to the unit of weeks “0”, the units star-wheel 54 drives the tens star-wheel 64 via the tens drive finger 60.

The “large date” display device 48 is supplemented by a correcting lever 68 which, when the user acts on a push button 70, allows the units star-wheel 54 to advance by one step each time this push button 70 is actuated.

In accordance with the invention, the “large date” display device 48 is equipped with a mechanism 72 for positioning an indicator in a reference position which comprises two cams, for example in the form of a snail 74, fixedly mounted beneath each of the units star-wheel 54 and tens star-wheel 64. Each of these snails 74 has a spiral-shaped profile 76 by means whereof they cooperate with one of the actuation faces 78 of a hammer 80 which is held elastically away from its active position in contact with these snails 74 by a spring 82. When the user uses a push button 84 to act on the hammer 80 against the elastic force of the spring 82, the hammer 80 falls onto the snails 74 and causes the latter to pivot until this hammer 80 bears in a stable manner on the end 86 of the spiral-shaped profiles 76 of the snails 74. The position of the snails 74 relative to the units star-wheel 54 and the tens star-wheel 64 is adjusted such that, when the hammer 80 falls on the snails 74, the units disc 52 and tens disc 62 are brought back to their reference position, preferably that in which they display the indication “01”.

It must be understood that, as a result of the use of the snails 74, the units disc 52 and tens disc 62 will always rotate in the same direction, regardless of where on the profile of the snails 74 the hammer 80 falls, and will stop when the hammer 80 comes to bear on the end 86 of the spiral-shaped profiles 76 of the snails 74. This is particularly advantageous insofar as, by forcing the correction of the units display and of the tens display in the opposite direction of rotation to that of the normal display of the week numbers, the “large date” display device 48 no longer briefly shows the non-existent week numbers 54 to 59.

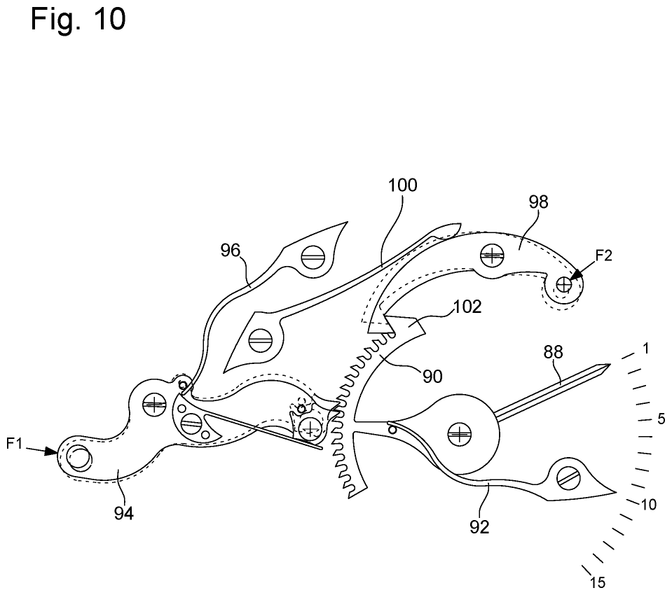

According to one specific embodiment of the invention illustrated in FIG. 10, the driving, correction and bringing back to the reference position, of an indicator, for example of an indicator hand 88 type, which points to the succession of indications of the time variable to be displayed, in this case a succession of 15 days, are carried out by a wolf-toothed rack 90 held in position by a first return spring 92 and whose movements are controlled by a correcting lever 94 held in position by a second return spring 96. The driving and stepped correction of the indicator hand 88 are carried out by driving the wolf-toothed rack 90 by one tooth each time, by means of the correcting lever 94, by exerting a force thereon as shown by the arrow F1. The wolf-toothed rack 90 is prevented from moving backwards by a pawl 98 held in position by a third return spring 100. The bringing of the indicator hand 88 back to its reference position is controlled by the user who actuates the pawl 98 as shown by the arrow F2, which has the effect of releasing the pawl 98 from the toothing of the wolf-toothed rack 90 and thus of releasing the wolf-toothed rack 90. Under the action of its return spring 92, the wolf-toothed rack 90 will thus be able to return to its rest position wherein the pawl 98 engages with a tooth 102 provided at the end of this wolf-toothed rack 90.

It goes without saying that the present invention is not limited to the embodiment described hereinabove and that various simple alternatives and modifications can be considered by a person skilled in the art without departing from the scope of the invention as defined by the accompanying claims. It must be noted in particular that a timepiece can be equipped with a plurality of devices for displaying a succession of indications of a time variable, each equipped with a mechanism for positioning an indicator in a reference position according to the invention, and that all of these display devices are simultaneously brought back to the reference position by one and the same action by the user on a single push button. It must also be noted in the figures accompanying the present patent application that the moving elements such as the correcting levers are shown via dotted lines in their rest position, and via solid lines in their active position.

### Nomenclature

1. Device for displaying a succession of indications of a time variable
2. Moon phase indicator
3. Moon phase wheel
4a, 4b. Moon indications
6. Drive finger
8. 24-hour wheel
10. Hours wheel
12. Jumper
14. First spring
16. Correcting lever
18. Second spring
20. First push button
22. Mechanism for positioning an indicator in a reference position
24. Heart-piece
26. Lower face
28. Indexing surface
30. Hammer
32. Third spring
34. Second push button
36. Snail
38. End
40. Spiral
42. Weeks of the year display device
44. Weeks of the year display wheel
46. Indicator hand
48. “Large date” display device
50. Units display assembly
51. Tens display assembly
52. Units disc
54. Units star-wheel
56. Units jumper
58. Units drive finger
60. Tens drive finger
62. Tens disc
64. Tens star-wheel
66. Tens jumper
68. Correcting lever
70. Push button
72. Mechanism for positioning an indicator in a reference position
74. Snails
76. Spiral-shaped profile
78. Actuation faces
80. Hammer
82. Spring
84. Push button
86. End
88. Indicator hand
90. Wolf-toothed rack
92. First return spring
94. Correcting lever
96. Second return spring
98. Pawl
100. Third return spring
102. Tooth

1. A device (1) for displaying a succession of indications of a time variable for a timepiece, this display device (1) comprising:
an indicator which carries the succession of indications of the time variable to be displayed or which points to this succession of indications of the time variable to be displayed, this indicator being arranged to be driven by a horological movement so as to move from an initial position to a final position through a succession of intermediate positions in which the display of the time variable passes from one indication to the next indication at a required frequency;
a mechanism (22; 72) for positioning the indicator in a reference position; and
an actuating device, the mechanism for positioning the indicator in a reference position comprising at least a cam on which acts, when actuated, the actuating device such that the mechanism for positioning the indicator in a reference position brings the indicator back to its predetermined reference position.

2. The device (1) for displaying a succession of indications of a time variable according to claim 1, wherein the cam is a heart-piece (24) or a snail (36; 74), the positioning whereof, relative to the indicator, determines the predetermined reference position of the indicator.

3. The device (1) for displaying a succession of indications of a time variable according to claim 2, wherein the mechanism for positioning the indicator in a reference position comprises a hammer (30; 80), the hammer (30; 80) being arranged such that, when actuated by means of the actuating device, it comes into an active position in contact with the heart-piece (24) or snail (36; 74), so as to pivot the indicator and bring it back into its predetermined reference position.

4. The device (1) for displaying a succession of indications of a time variable according to claim 3, wherein the heart-piece (24) or the snail (36, 74) is fixedly mounted on the indicator.

5. The device (1) for displaying a succession of indications of a time variable according to claim 1, wherein the cam is a heart-piece (24) or a snail (36, 74) fixedly mounted at a place on a frame of the timepiece and wherein the mechanism for positioning the indicator in a reference position comprises a hammer (30; 80) mounted on the indicator.

6. The device (1) for displaying a succession of indications of a time variable according to claim 3, wherein, in order for the hammer (30; 80) to be actuated, the actuating device comprises a push button (34; 84) which acts against the elastic force of a spring (32; 82) arranged to keep the hammer (30; 80) away from an active position in contact with the heart-piece (24) or snail (36, 74).

7. The device (1) for displaying a succession of indications of a time variable according to claim 2, wherein the indicator is a 59-tooth moon phase wheel (3) which carries two moon indications (4a, 4b) and which is driven by the horological movement at a rate of one step per day.

8. The device (1) for displaying a succession of indications of a time variable according to claim 7, wherein the predetermined reference position of the moon phase wheel (2) corresponds to the full moon display position.

9. The device (1) for displaying a succession of indications of a time variable according to claim 2, wherein the indicator is a 53-tooth wheel (44) displaying the weeks of the year which carries an indicator hand (46) which moves opposite a graduation bearing the week numbers from 1 to 53.

10. The device (1) for displaying a succession of indications of a time variable according to claim 9, wherein the predetermined reference position of the weeks of the year display wheel (44) corresponds to the week “1” display position.

11. The device (1) for displaying a succession of indications of a time variable according to claim 2, wherein the device is of the “large date” type and wherein the indicator whereof comprises a units display assembly (50) for displaying the units of the week numbers, and a tens display assembly (51) for displaying the tens of the week numbers.

12. The device (1) for displaying a succession of indications of a time variable according to claim 11, wherein the units display assembly (50) comprises a units disc (52) on which the units of the week numbers 0 to 9 are inscribed and which is fixed to a units star-wheel (54) with 10 teeth, and wherein the tens display assembly (51) comprises a tens disc (62) on which the tens of the week numbers 0 to 5 are inscribed and which is fixed to a tens star-wheel (64) with 6 teeth, the mechanism for positioning the indicator in a reference position comprising a heart-piece or a snail (74) fixedly mounted beneath each of the units (54) and tens (64) star-wheels, and the actuating device comprising a hammer (80) falling on the heart-pieces or snails (74), causing the units disc (52) and the tens disc (62) to be pivoted simultaneously in order to bring them back into their predetermined reference position.

13. The device (1) for displaying a succession of indications of a time variable according to claim 12, wherein the predetermined reference position of the units disc (52) and of the tens disc (62) corresponds to the display of the indication “01”.

14. A device (1) for displaying a succession of indications of a time variable for a timepiece, the display device (1) comprising:
an indicator which carries the succession of indications of the time variable to be displayed or which points to this succession of indications of the time variable to be displayed, this indicator being arranged to be driven by a horological movement so as to move from an initial position to a final position through a succession of intermediate positions in which the display of the time variable passes from one indication to the next indication at a required frequency;
a mechanism for positioning the indicator in a reference position; and
an actuating device,
the mechanism for positioning the indicator in a reference position comprising a wolf-toothed rack (90) which drives, corrects and brings back, into the reference position, the indicator carrying the succession of indications of the time variable to be displayed or pointing to the succession of indications of the time variable to be displayed, the driving and correction of the indicator being carried out by driving the wolf-toothed rack (90) by one tooth, the reverse motion whereof is prevented by a pawl (98), and the positioning of the indicator in a reference position being ensured by actuating the pawl (98), which releases the wolf-toothed rack (90), the latter returning to its rest position under the action of a return spring (92), in which the pawl (98) engages with a tooth (102) provided at the end of this wolf-toothed rack (90).

15. The device (1) for displaying a succession of indications of a time variable according to claim 1, wherein the positioning, into the reference position, of the indicator carrying the succession of indications of the time variable to be displayed or pointing to the succession of indications of the time variable to be displayed can be controlled by the user by acting on a first push button, whereas a second push button is arranged to ensure the stepped correction of the indicator, independently of the first push button.

16. The device (1) for displaying a succession of indications of a time variable according to claim 1, wherein the positioning, into the reference position, of the indicator carrying the succession of indications of the time variable to be displayed or pointing to the succession of indications of the time variable to be displayed is carried out automatically upon a first action on a push button which is arranged to control the stepped correction of the indicator upon a second action on the same push button

17. A timepiece comprising at least one display device (1) according to claim 1.

18. The timepiece according to claim 17, wherein it comprises a plurality of display devices (1) arranged such that they can be repositioned simultaneously into the reference position by one and the same action of the user on a single push button.
